(19) United States
(12) Patent Application Publication
(10) Pub. No.: US 2003/0169547 A1
(43) Pub. Date: Sep. 11, 2003

(54) System and method for delivering electrical power with physical and elecrical isolation

(76) Inventor: Walter William Stumberger, Hightstown, NJ (US)

Correspondence Address: Walter W. Stumberger, 203 Dutch Neck Road, Hightstown, NJ, 08520, US

(21) Appl. No.: 10/094,769

(22) Filed: Mar. 11, 2002

(51) Int. Cl. H02H 9/00

(52) U.S. Cl. 361/58

(57) ABSTRACT

This invention separates input electrical power, typically a public power grid, from output electrical power, typically for use by electrically sensitive equipment, by converting the electrical energy into mechanical energy, transferring that mechanical energy, by way of a non-conductive transfer medium, through a non-conductive conduit, to a protected system that converts the mechanical energy back into useable and protected electrical power.

### STATEMENT REGARDING FEDERALLY SPONSORED RESEARCH OR DEVELOPMENT

No federal funds were used to sponsor the research or development of this invention.

### BACKGROUND OF THE INVENTION

The proliferation of Electromagnetic Pulse (EMP) Weapons, Flux Compression Generators (E-Bombs), Compton Effect Generators and other high-energy weapons increase the danger that the public power grid will be used as a delivery method for powerful electrical surges able to destroy the functionality of delicate electrical devices such as those found in computer systems and telephone exchanges. Under some circumstances high-energy, high frequency, electrical arching of 20 to 30 feet, or more, has been demonstrated and this arching can pass through power distribution systems to the end user both by way of the electrical wire and the fact that most of the physical plant used for power distribution is made of conductive materials.

By converting the electrical energy into mechanical energy, this invention helps prevent the transmission of electrical surges by physically and electrically isolating the public power grid from the local power system through physical distance and electrical insulation.

This invention relates to the fields of electricity generation, mechanical processes involved in converting rotational energy into mechanical energy and mechanical energy into rotational energy, electrical transmission, electrical insulation, and power system surge protection.

No similar or prior system for this type of physical isolation and electrical insulation in the delivery of electrical power has been identified. Many systems and devices for converting electrical energy into mechanical energy and mechanical energy into electrical energy are in the public domain. This invention proposes and uses these systems plus the addition of insulating materials in a novel way to accomplish a novel result.

### BRIEF SUMMARY OF THE INVENTION

This invention converts the Source electricity (or other provided power) into a mechanical force that is impressed onto a dielectric medium. The dielectric medium is carried through dielectric pipes to a remote conversion system. The remote conversion system changes the mechanical force back into electrical energy.

By converting the incoming electrical energy into mechanical energy, this invention helps prevent the transmission of electrical surges by mechanically and electrically isolating the external power source, and the power source's associated hardware, from the internal power system through physical distance and electrical insulation.

Since the remote converter can be located inside a protective shield, or protected building, it can supply isolated, protected, and conditioned, electrical power.

### BRIEF DESCRIPTION OF THE SEVERAL VIEWS OF THE DRAWING

FIG. 1 shows a single input and single output configuration for this invention.

Electric power source (1) drives electric motor (2) applying rotational force to torque converter (3). Torque converter (3) changes the rotational force from electric motor (2) into mechanical energy that is applied to a dielectric transfer medium (4) which is carried through the dielectric conduit (5) to torque converter (6). Torque converter (6) converts the mechanical energy of the dielectric transfer medium (4) into rotational force that drives generator (7). Generator (7) supplies electrical power for load (8).

Dielectric conduit (9) returns the dielectric medium (4) to the torque converter (3) where the dielectric medium (4) imparts any unused energy to torque converter (3) and is re-circulated.

Attachment point (101) can be used for the connection of an auxiliary power input source device. Attachment point (102) can be used for an auxiliary power output device.

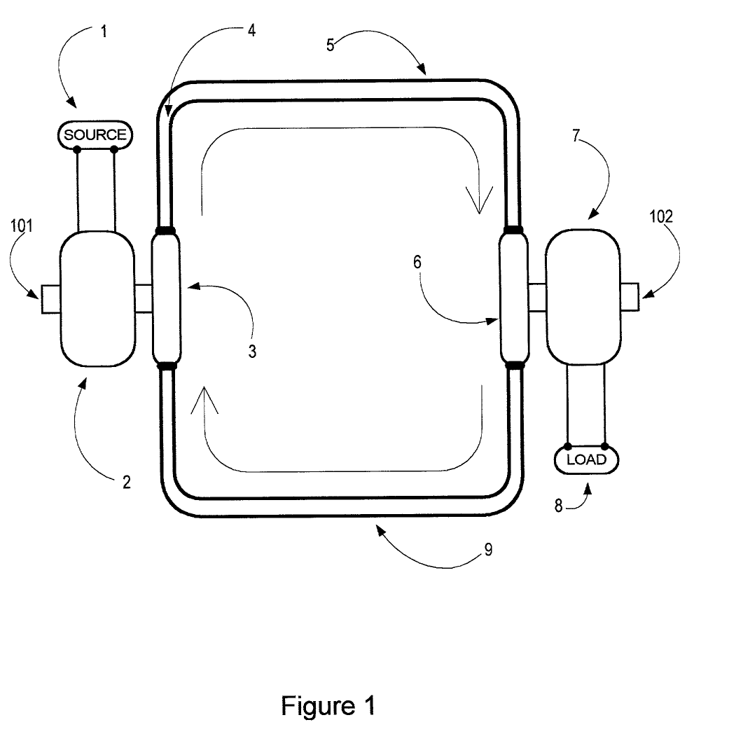

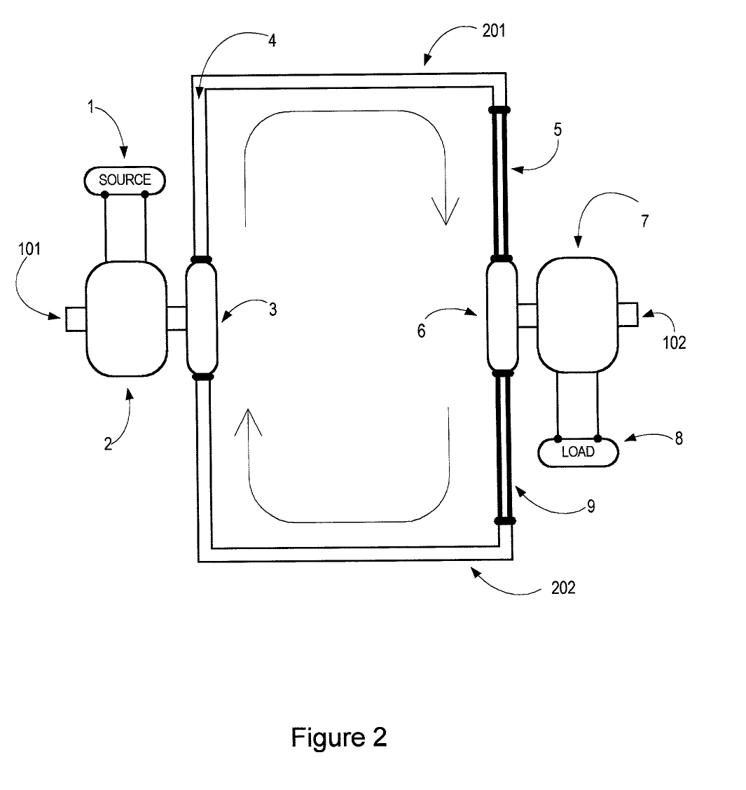

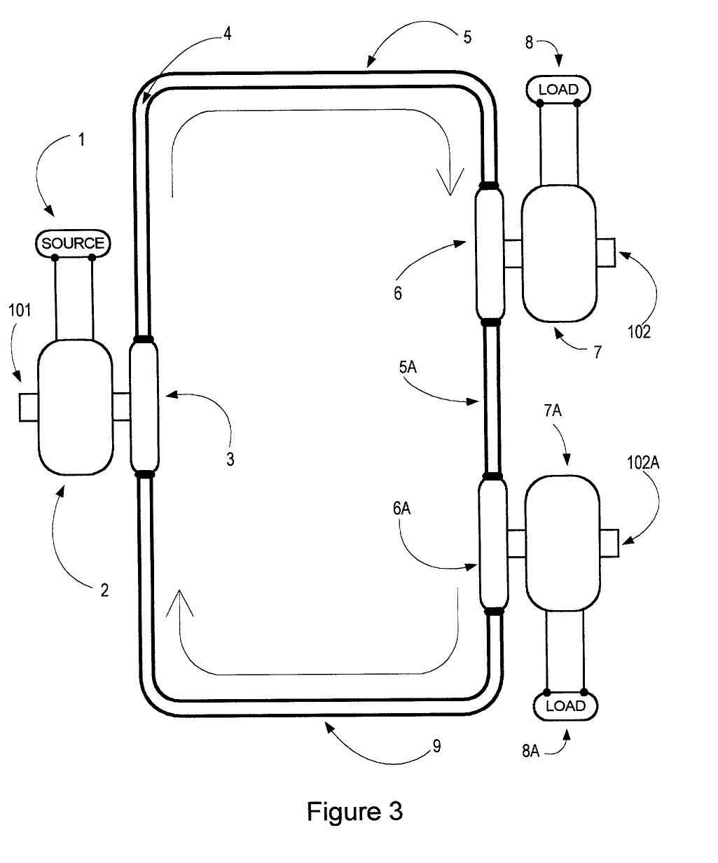

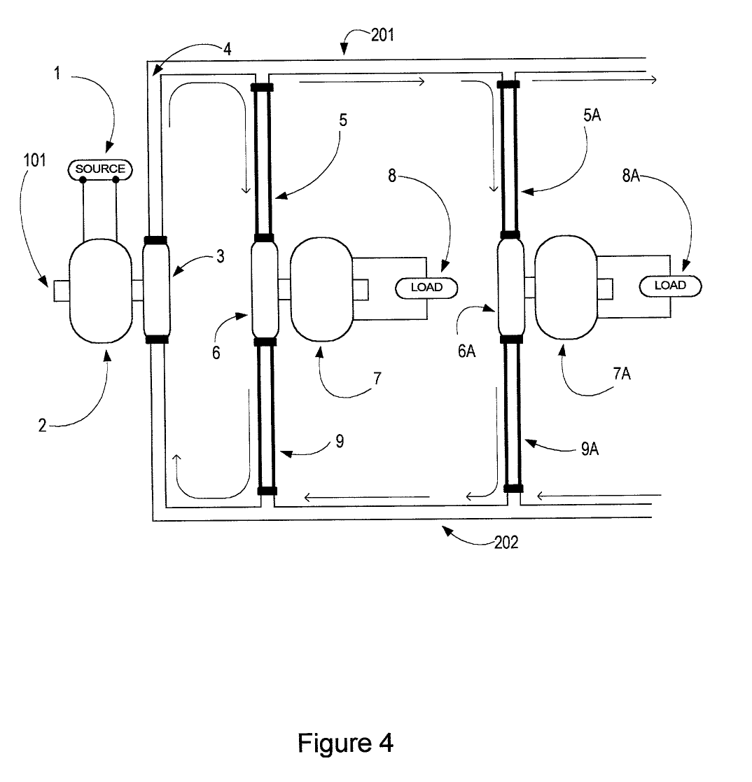

FIG. 2 is similar to FIG. 1 and has the addition of items 201 and 202 which are conduits of any type and allow for an extended physical relationship between the input and the output and still maintain electrical isolation and insulation.

FIG. 3 shows the invention in a series output configuration with physical and electrical isolation and insulation by adding additional equipment clusters shown as parts 5A, 6A, 7A, 8A, 9A and 102A.

FIG. 4 shows the invention in a parallel output configuration with physical and electrical isolation and insulation by adding additional equipment clusters shown as parts 5A, 6A, 7A, 8A, and 9A. In this configuration conduits 201 and 202 are extended to accommodate additional equipment clusters not shown.

From the foregoing it will be appreciated by those skilled in the art that the present invention provides a particularly effective and advantageous method of and apparatus for overcoming many of the limitations associated with connecting electrical Loads (8) with electrical Sources (1) in close electrical proximity. It will also be readily appreciated by one with ordinary skill in the art to use the method and apparatus of the present invention in other configurations.

Although certain presently preferred embodiments of the present invention have been specifically described herein it will be apparent to those skilled in the art to which the invention pertains that variations and modifications of the various embodiments shown and described herein may be made without departing from the spirit and scope of the invention

### DETAILED DESCRIPTION OF THE INVENTION

The invention consists of a collection of mechanical, electrical and components connected in such a way that electrical energy from a Source (1) is delivered as electrical energy to Load (8) with sufficient electrical and physical separation so as to prevent any incoming electrical surges at the Source (1) from reaching and affecting Load (8).

In one typical embodiment (see FIG. 1) electrical power form the Source (1) is applied to electric motor (2), which drives torque converter (3). Torque converter (3) impresses mechanical energy onto a dielectric energy transfer medium (4). Dielectric energy transfer medium (4) is carried through a dielectric conduit (5) to torque converter (6). Torque converter (6) converts the mechanical energy of the dielectric energy transfer medium (4) into rotational energy to drive generator (7). Generator (7) provides electrical power to the Load (8).

After leaving torque converter (6) the dielectric energy transfer medium (4) is carried back to torque converter (3) through dielectric conduit (9), where any residual mechanical energy the dielectric transfer medium (4) has, can be returned to torque converter (3) to help improve the efficiency of the system.

Alternative mechanical devices such as an internal combustion engine, or a turbine engine, or other device, can be attached to the system at connector (101) if desired.

The system can be configured with a plurality of serial or parallel inputs and a plurality of serial or parallel outputs, using a plurality of equipment clusters, so long as physical and electrical isolation is maintained.

While this illustrates and describes what are at present considered to be preferred embodiments of the present invention it will be understood by those skilled in the art that various changes and modifications may be made, and equivalents may be substituted for elements thereof without departing from the true scope of the present invention. In addition, many modifications may be made to adapt a particular situation or material to the teaching of this invention without departing from the central scope of this invention. Therefore, it is intended that the present invention not be limited to the particular embodiment disclosed as the best mode contemplated for carrying out the present invention, but that the present invention includes all embodiments falling within the scope of the appended claims.

1. We claim that this invention is a system and methodology for distributing electrical power, with physical isolation and electrical insulation between an input power source (1) and an output power load (8),
with said system and method including a torque converter (3) with an electric motor attached and a torque converter (6) with a generator attached and
with said torque converters (3 and 6) physically connected and electrically separated by segments of dielectric conduit (5 and 9) and
with said dielectric conduit carrying a dielectric energy transfer medium (4).
We claim that this invention is a system and methodology for distributing electrical power from a plurality of power sources, with physical isolation and electrical insulation between the input power sources and the output power loads,
with said system and method including a plurality of torque converters with each having an electric motor attached and a plurality of torque converters each with a generator attached in a plurality of series and parallel configurations,
with said torque converters physically connected and electrically separated by segments of dielectric conduit and
with said dielectric conduit carrying a dielectric energy transfer medium in a plurality of possible configurations.
We claim that this invention is a system and methodology for distributing electrical power from a plurality of power sources, with physical isolation and electrical insulation between the input power sources and the output power loads,
with said system and method including a plurality of torque converters with each having an electric motor or other power generating equipment attached and a plurality of torque converters each with a generator attached in a plurality of series and parallel configurations,
with said torque converters physically connected and electrically separated by segments of dielectric conduit and
with said dielectric conduit carrying a dielectric energy transfer medium in a plurality of possible configurations.
From the foregoing, it will be appreciated by those skilled in the art that the present invention provides a particularly effective and advantageous method of and apparatus for overcoming many of the limitations associated with connecting electrical Loads (8) with electrical Sources (1) in close electrical proximity. It will also be readily appreciated by one with ordinary skill in the art to use the method and apparatus of the present invention in other configurations. Although certain presently preferred embodiments of the present invention have been specifically described herein, it will be apparent to those skilled in the art to which the invention pertains that variations and modifications of the various embodiments shown and described herein may be made without departing from the spirit and scope of the invention
The attached descriptions and drawings and claims are regarded by the applicant as including a variety of individually inventive concepts, some of which may lie partially or wholly outside the scope of some or all of the claims. The fact that the applicant has chosen, at the time of filing of the present application, to restrict the claimed scope of protection in accordance with the attached claims is not to be taken as a disclaimer for alternative inventive concepts that are included in the contents of the application and could be defined by claims differing in scope from the attached claims, which different claims may be adopted at some later time.
